(19) United States
(12) Patent Application Publication
(10) Pub. No.: US 2008/0183479 A1
(43) Pub. Date: Jul. 31, 2008

(54) BUSINESS PROCESS RECONSTRUCTION METHOD, AND ITS PROGRAM AND COMPUTER

(76) Inventors: MASARU IWASHITA, Kawasaki (JP); Katsutoshi Asaki, Kawasaki (JP); Nobuyuki Yamamoto, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/851,449

(22) Filed: Sep. 7, 2007

(30) Foreign Application Priority Data
Jan. 25, 2007 (JP) 2007-014885

(51) Int. Cl. G06Q 10/00

(52) U.S. Cl. 705/1

(57) ABSTRACT

A system managing computer communicable with an ESB execution computer has a storage portion for storing deploy information which has service names for designating services constructing a business process and service-deployed ESB execution computers in association with each other. And, it has a processing portion which, based on the deployment information, extracts a combination of plural successive services executable by the ESB execution computers different from the ESB execution computer, defines the extracted combination of the services as a new business process to be deployed on the ESB execution computer, and reconstructs a business process to be deployed on the ESB execution computer as a business process for calling a newly defined business process.

### INCORPORATION BY REFERENCE

The present application claims priority from Japanese application JP2007-014885 filed on Jan. 25, 2007, the content of which is hereby incorporated by reference into this application.

### BACKGROUND OF THE INVENTION

The present invention relates to a technology of reconstructing a business process by using business process definition information and deployment destination information of a service which constructs the business process.

In recent years, there is demanded a system which can flexibly comply in a short time with severe changes of business environments around corporations, such as merger and abolition of corporations and stiffer market competition, and a system which is based on the concept of an SOA (Service Oriented Architecture) is attracting attention. The SOA is one of the concepts of software constructions that software having a certain independent function significant in conducting business is constructed in the unit called a service, and interface information of the service defining the name and an input/output message format of the service is made public, thereby proposing the provision of the function. Here, the system constructed based on the concept of the SOA is called an SOA system.

The SOA system reuses an existing service as much as possible, develops a new service if necessary and combines such services to provide a new function, thereby capable of flexibly responding to changes in business. As described above, a new service which is provided by combining plural services is called a business process. And, in a case where the service of the SOA system is used, a client as a user of the service does not directly call the service but uses the service via middleware such as an ESB (Enterprise Service Bus) as an intermediate, so that the business and the system can be managed separately. Thus, it is easy to flexibly respond to changes in business environments.

The ESB is one of middleware for realization of the SOA system and has an intermediate function between the service and the client as the user of the service. Use of the ESB eliminates necessary of direct communications between the client and the service, making it possible to sparsely keep the relationship between the client and the service. In addition to the intermediate function, the ESB has protocol conversion and data conversion functions to provide a function to absorb a difference between the client's application and the service's application and a function to manage the service execution history. The ESB may also have a business process execution function and a function to collaborate mutually between ESBs. Here, the ESB is determined as middleware having an intermediate function between the client and the service, a business process execution function and an inter-ESB collaboration function.

The business process uses a business process definition language (business process description language) such as a BPEL (Business Process Execution Language) and combines it with plural services to provide a new function, and the business process itself also becomes a service. Therefore, it is also possible to combine business processes to construct a new business process. Since the business process combines services having an independent function to provide a function, if it is necessary to change the function, the change can be made by simply changing the combination of the services. Thus, the business process can flexibly respond to changes in the business. Into the business process can be written flow control such as a branch process and a format editing processing in addition to a service call, and such elements constructing the business process are called activities. And, in the business process, a region for storing a message instance used for each activity is called a variable. The variable can be used for a service call input/output message, a branch condition for the branch processing, and the like.

As a business process description method, the business process definition language (business process description language) such as the BPEL described above is used. As an installation method of the business process and the service, various types of component models are used. And, as execution programs for the business process and the service, various types of programs for executing the mounted components are used. Here, the execution program for the service is called the service execution program.

A business process developer who defines the business process is a user of the SOA system to conduct a job by using the business process to be defined and does not have knowledge about the system configuration like a manager of the SOA system. Therefore, it is required that the business process developer can define the business process without being conscious of the structure of the system deployed in the SOA system. And, the business process execution function is required to have a function to select a service optimum for execution of the individual activities constructing the business process from the system.

There is US 2005/0149367A1 as a technology to make the business process executable by analyzing the business process definition and allocating appropriate services to the individual activities constructing the business process. This technology discloses a method for selecting services optimum for execution of the individual activities from previously registered services and allocating them to make it possible to execute the business process.

With the development of the SOA in future, it becomes that the SOA systems collaborate mutually to provide the service. The provision of the service by the collaboration of the plural SOA systems can expand the range of the service usable by the client. Here, the collaboration method for mutual collaboration of the SOA systems is realized by collaboration of both ESBs. It is because the security and maintenance property of the service and the easiness of the execution history management can be improved by making it possible that the ESB has an intermediate function to use the service and the service calling can be made from only the ESB.

But, in an environment that the service is provided by the collaboration between plural ESBs, the technology disclosed by the US 2005/0149367A1 might have inefficient inter-ESB collaboration. Specifically, where the services, which are deployed on an ESB different from the ESB on which the business process is deployed, are called successively, the inter-ESB collaboration is performed every time the service is called, so that the same number of collaborations as the number of successive services is required. But, if plural services could be executed by a single inter-ESB collaboration, the number of times of the inter-ESB collaboration can be decreased, and the business process execution performance can be improved.

### SUMMARY OF THE INVENTION

Accordingly, the present invention remedies a problem that it is necessary to decrease the inefficient inter-ESB collaboration which is performed at the execution of the business process by a system to provide a service by collaboration of plural ESBs.

The present invention has been made to solve the above problem and determines that a computer, which is used for a business process management system that a business process processing unit of a subsystem having one or plural computers communicable with the business process processing unit collaborates with a business process processing unit of different one or plural subsystems over a network to perform a processing of a business process. The computer has a storage portion which stores deployment information having information capable of specifying services constructing the business process in correspondence with a business process processing unit having the deployed services and business process definition information having the business process defined, and a processing portion which processes information. The processing portion extracts from the business process definition information a combination of plural successive services executable by a business process processing unit different from a business process processing unit belonging to the same subsystem as the computer on the basis of the deployment information, and defines the extracted combination of the services as a new business process which is deployed on the different business process processing unit, and reconstruct the business process as a business process for calling the new business process.

Other objects, features and advantages of the invention will become apparent from the following description of the embodiments of the invention taken in conjunction with the accompanying drawings.

### BRIEF DESCRIPTION OF THE DRAWINGS

FIG. 1 is an example of a configuration view of the entire system according to a first embodiment.

FIG. 2 is an example of a configuration view of an SOA system according to the first embodiment.

FIG. 3 is an example of a configuration view of a system managing computer 400 of FIG. 1.

FIG. 4 is an example of a configuration view of a collaboration destination ESB information management table 240 of FIG. 2.

FIGS. 5A and 5B are diagrams showing structures of service deployed state management tables according to the embodiment, FIG. 5A shows a state before the registration of a newly defined business process, and FIG. 5B shows a state after the registration of a newly defined business process by the business process reconstruction of the invention.

FIGS. 6A and 6B are diagrams showing structures of provided service list management tables according to the embodiment, FIG. 6A shows a state before the registration of a newly defined business process, and FIG. 6B shows a state after the registration of a newly defined business process by the business process reconstruction of the invention.

FIG. 7 is an example of a flow chart of an implementing procedure of this embodiment, showing a processing execution order of a business process analysis portion, a business process reconstruction portion and a business process delivery portion.

FIG. 8 is a diagram showing a processing flow of a reconstruction algorithm of business process definition of FIG. 7, showing a flow of the processing executed by the business process reconstruction portion.

FIG. 9 is an example of definition of a business process.

FIG. 10 is an example of definition of a business process including a control structure.

FIG. 11 is an example of a flow chart of a region analysis algorithm of FIG. 8.

FIG. 12 is an example of an intermediate step of business process reconstruction.

FIG. 13 is an example of results of the business process reconstruction.

FIG. 14 is an example of definition of the business process including a variable declaration.

FIG. 15 is an example of reconstruction results of the business processes including a variable declaration.

FIG. 16 is an example of a sequence diagram when a business process is executed before the application of a business process reconstruction algorithm.

FIG. 17 is an example of a sequence diagram when a business process is executed after the application of a business process reconstruction algorithm.

FIG. 18 is an example of a configuration view of an SOA system according to a second embodiment.

FIG. 19 is an example of a configuration view of a business process reconstruction history management table of FIG. 18.

### DETAILED DESCRIPTION OF EMBODIMENTS

Embodiments of the invention are described below in detail with reference to the drawings. First, a first embodiment is described.

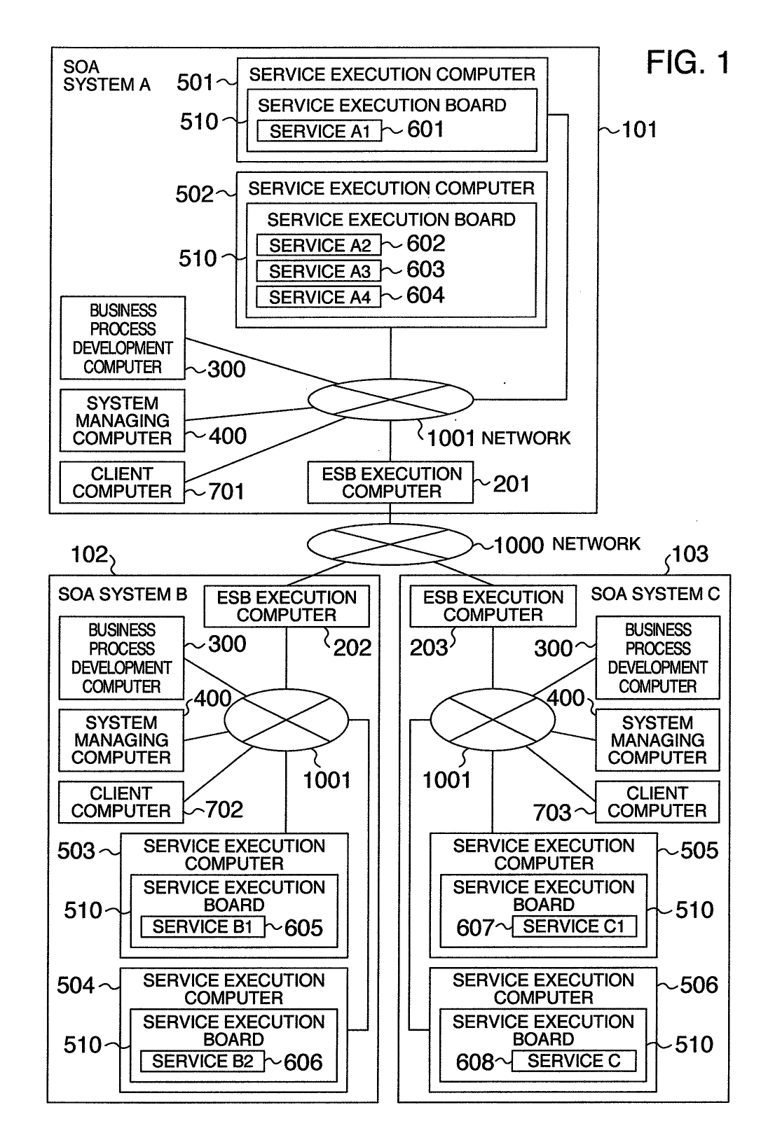

FIG. 1 shows an example of the system configuration according to this embodiment. FIG. 1 is a conceptual diagram of the entire system of the embodiment, and details of the insides of the individual computers are described later.

As shown in FIG. 1, this embodiment illustrates an example of a system that three SOA systems 101 to 103 of an SOA system A (101), an SOA system B (102) and an SOA system C (103) make ESB execution computers (business process processing units) 201 to 203 which are computers for executing ESB middleware belonging to the individual SOA systems 101 to 103 to be mutually communicable over a network 1000, thereby providing services in collaboration with each other. The number of the SOA systems is not limited to three but may be sufficient by being plural. And, the network 1000 may be a local network such as a LAN (Local Area Network) or an intranet, or a global network such as the Internet. And, a system that the ESB execution computers 201 to 203 process the business process in collaboration with each other over the network 1000 is called a business process management system. In addition, this embodiment uses the SOA system as an example of a subsystem that at least one system managing computer (also simply called the “computer”) 400 and the ESB execution computer 201 (201 to 203) are determined to be communicable.

The individual SOA systems 101 to 103 of this embodiment are comprised of the ESB execution computers 201 to 203 for executing the ESB, a business process development computer 300 for developing the business process, the system managing computer (simply also called the “computer”) 400 for managing the SOA systems 101 to 103, client computers 701 to 703 for transmitting a service execution request to the ESB execution computers 201 to 203, service execution computers 501 to 506 for executing services, and networks 1001 for making the above computers to be communicable mutually. The networks 1001 may be a local network or a global network. The individual SOA systems 101 to 103 may have the business process development computer 300, the system managing computer 400, the client computer 701 (701 to 703), and the service execution computer 501 (501 to 506) in plural.

As shown in FIG. 1, in the SOA system A (101) of this embodiment, the ESB execution computer 201, the business process development computer 300, the system managing computer 400, the client computer 701 and the service execution computers 501, 502 are determined to be communicable mutually over the network 1001, a service A1 (601) is deployed on a service execution board 510 on the service execution computer 501, and a service A2 (602), a service A3 (603) and a service A4 (604) are deployed on a service execution board 510 on the service execution computer 502. The service to be deployed on the individual service execution boards 510 on the service execution computers 501, 502 may be one as in the service execution computer 501, plural as in the service execution computer 502, or omitted.

Similar to the SOA system A (101), in the SOA system B (102), the ESB execution computer 202, the business process development computer 300, the system managing computer 400, the client computer 702 and the service execution computers 503, 504 are arranged to be communicable mutually over the network 1001, a service B1 (605) is deployed on the service execution board 510 on the service execution computer 503, and a service B2 (606) is deployed on the service execution board 510 on the service execution computer 504.

In addition, in the SOA system C (103), the ESB execution computer 203, the business process development computer 300, the system managing computer 400, the client computer 703 and the service execution computers 505, 506 are arranged to be communicable mutually over the network 1001, a service C1 (607) is deployed on the service execution board 510 on the service execution computer 505, and a service C2 (608) is deployed on the service execution board 510 on the service execution computer 506.

In this embodiment, the ESB execution computers 201 to 203 are determined to be communicable mutually over the network 1000, so that the services deployed on the different SOA systems 101 to 103 can be used. For example, the service B1 (605) or the service C1 (607) which is deployed on the other SOA system, which is the SOA system B (102) or the SOA system C (103), can be used from the client computer 701 belonging to the SOA system A (101). For example, to use the service B1 (605) from the client computer 701, the client computer 701 first transmits a service execution request to the ESB execution computer 201 which belongs to the same SOA system A (101) as the client computer 701. Then, the ESB execution computer 201 having accepted the service execution request transfers the service execution request to the ESB execution computer 202 which is a deployment destination of the service B1 (605), and the service execution request is transmitted from the ESB execution computer 202 to the service execution computer 503 to execute the service B1 (605). The executed result of the service B1 (605) is returned to the client computer 701 through the route in reverse order of the transmission of the service execution request. The service execution request contains information for specifying at least the service B1 (605).

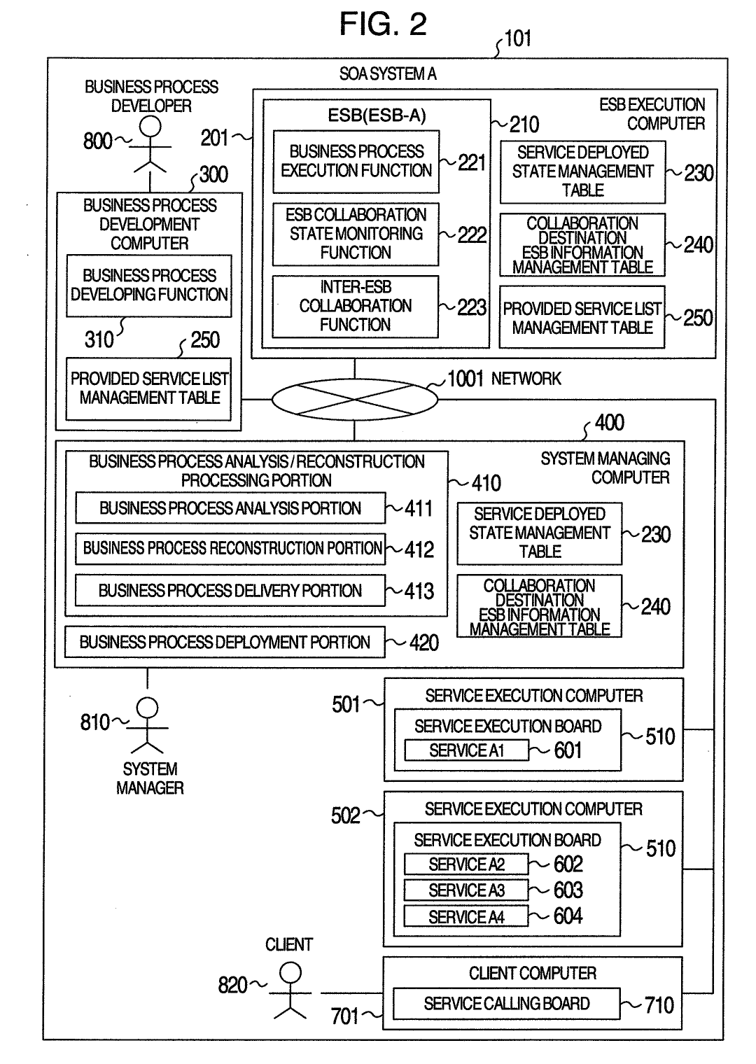

FIG. 2 shows an example of the detailed system configuration of the SOA system A (101) of FIG. 1. FIG. 2 shows an example of the system configuration of the SOA system A (101) of FIG. 1, but since the SOA system B (102) of FIG. 1 and the SOA system C (103) of FIG. 1 also have the same system configuration, the descriptions of the SOA system B (102) and the SOA system C (103) are omitted.

As shown in FIG. 2, the ESB execution computer 201 of the embodiment is composed of a general-purpose computer such as a personal computer and the ESB 210 which is middleware executed thereon. The ESB 210 has as its functions a business process execution function 221 to execute the business process in response to a request from the client, an ESB collaboration state monitoring function 222 to collect information of a collaboration destination ESB, and an inter-ESB collaboration function 223 to provide a service in collaboration with another ESB. In the following description, the ESB which operates on the ESB execution computer 201 belonging to the SOA system A (101) is called an ESB-A, the ESB which operates on the ESB execution computer 202 belonging to the SOA system B (102) of FIG. 1 is called an ESB-B, and the ESB which operates on the ESB execution computer 203 belonging to the SOA system C (103) of FIG. 1 is called an ESB-C, if necessary.

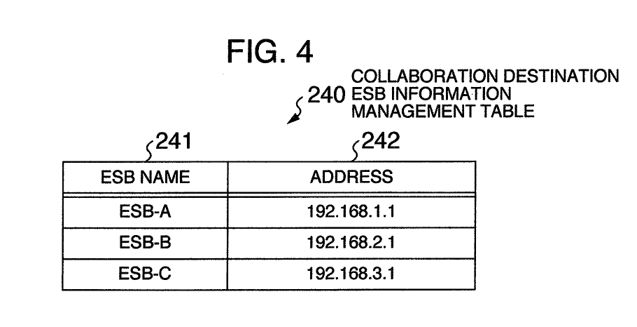

The ESB collaboration state monitoring function 222 obtains the addresses of ESBs, which can be collaborated mutually, from the input by a system manager 810 or from the ESB collaboration state monitoring function 222 of the collaboration destination ESB and stores the address of the collaboration destination ESB into a collaboration destination ESB information management table 240. Details of the structure of the collaboration destination ESB information management table 240 will be described later (see FIG. 4). The ESB collaboration state monitoring function 222 stores information, which has information for specifying the ESB and the address of the ESB in association with each other, into the collaboration destination ESB information management table 240. This embodiment uses the ESB name as the information for specifying the ESB and an IP (Internet Protocol) address as an ESB address but does not limit to them.

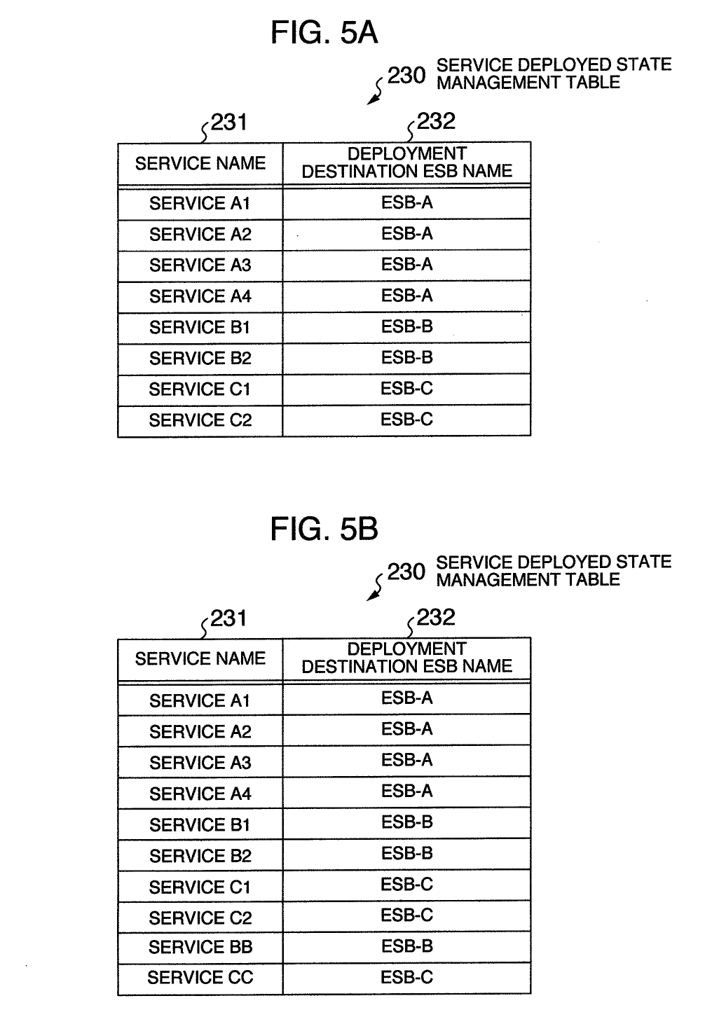

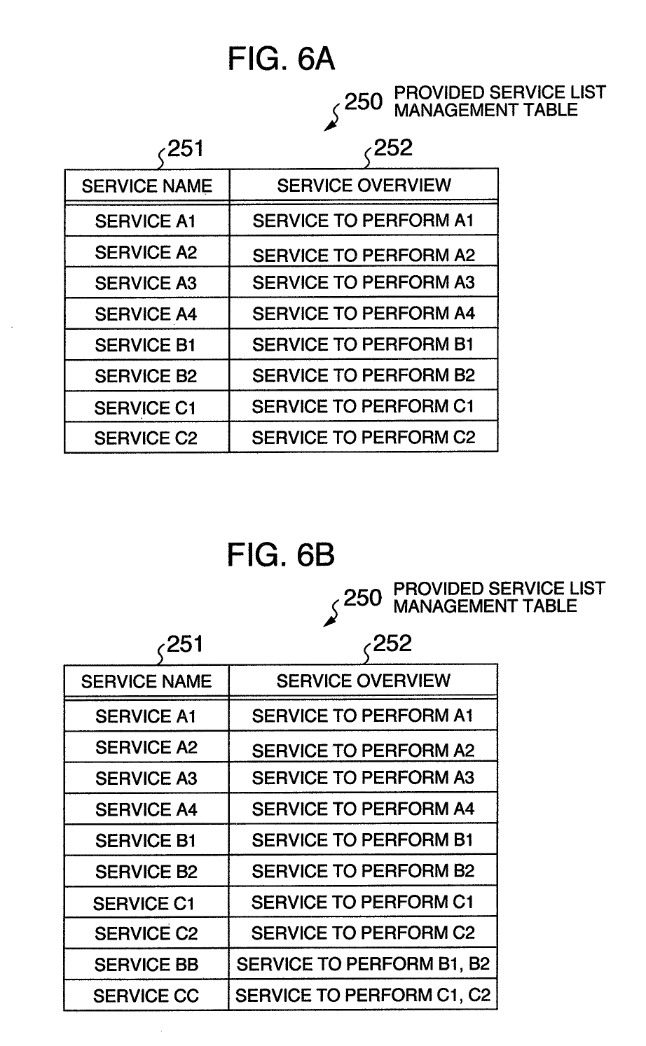

The ESB collaboration state monitoring function 222 also obtains the address of the collaboration destination ESB from the collaboration destination ESB information management table 240 and communicates with the ESB collaboration state monitoring function which operates on the collaboration destination ESB. At this time, the ESB collaboration state monitoring function 222 performs a processing to transmit information of the service deployed on its ESB 210 to the ESB collaboration state monitoring function on the collaboration destination ESB, and performs a processing to receive information of the service deployed on the collaboration destination ESB from the ESB collaboration state monitoring function on the collaboration destination ESB and to store the information into a service deployed state management table 230 and a provided service list management table 250. The information of the service includes at least information capable of specifying the service, for example, the service name and its service overview. The service overview will be described later. The ESB collaboration state monitoring function 222 stores information (deployment information) with the service name and its service deployment destination ESB name in association with each other into the service deployed state management table 230. Details of the structure of the service deployed state management table 230 will be described later (see FIG. 5). And, the ESB collaboration state monitoring function 222 stores information with the service name and its service overview in association with each other. The structure of the provided service list management table 250 will also be described later (see FIG. 6).

The inter-ESB collaboration function 223 communicates with the inter-ESB collaboration function 223 which operates on the collaboration destination ESB to perform a processing to make the service deployed on the collaboration destination ESB usable between them. At this time, the inter-ESB collaboration function 223 searches the collaboration destination ESB information management table 240 with the deployment destination ESB name used as a key to obtain the address of the collaboration ESB and uses the obtained address to realize the inter-ESB collaboration.

The above-described ESB functions such as the business process execution function 221, the ESB collaboration state monitoring function 222 and the inter-ESB collaboration function 223 can be realized by using a general-purpose ESB, so that their detailed description is omitted.

In this embodiment, the business process development computer 300 is comprised of at least a general-purpose computer such as a personal computer, a business process developing function 310 which is executed on it, and the provided service list management table 250 as shown in FIG. 2. The business process developing function 310 is usually a GUI (Graphical User Interface) program which is used to execute a business process definition by a business process developer 800 but not limited to it, and it may be mounted as dedicated hardware such as a semiconductor circuit. It is assumed in this embodiment that the business process developing function 310 is realized as a program. The business process developing function 310 refers to the provided service list management table 250, presents a list of services usable for the business process definition to the business process developer 800, and the business process developer 800 combines the presented services to define the business process. In this embodiment, both the business process development computer 300 and the ESB execution computer 201 keep the provided service list management table 250 having the same contents. Therefore, it may be configured such that the provided service list management table 250 is present on one of the computers, and the other computer refers to the table. And, since the business process developing function 310 can be realized by a general-purpose business process developing program or the like, its detailed description is omitted.

The business process defined by the business process developer 800 using the business process developing function 310 is input to a business process analysis/reconstruction processing portion 410 which is on the system managing computer 400 by the system manager 810.

In this embodiment, the system managing computer 400 is comprised of a general-purpose computer such as a personal computer, the business process analysis/reconstruction processing portion 410 as a processing portion which is executed on it, a business process deployment portion 420, the service deployed state management table 230, and the collaboration destination ESB information management table 240 as shown in FIG. 2.

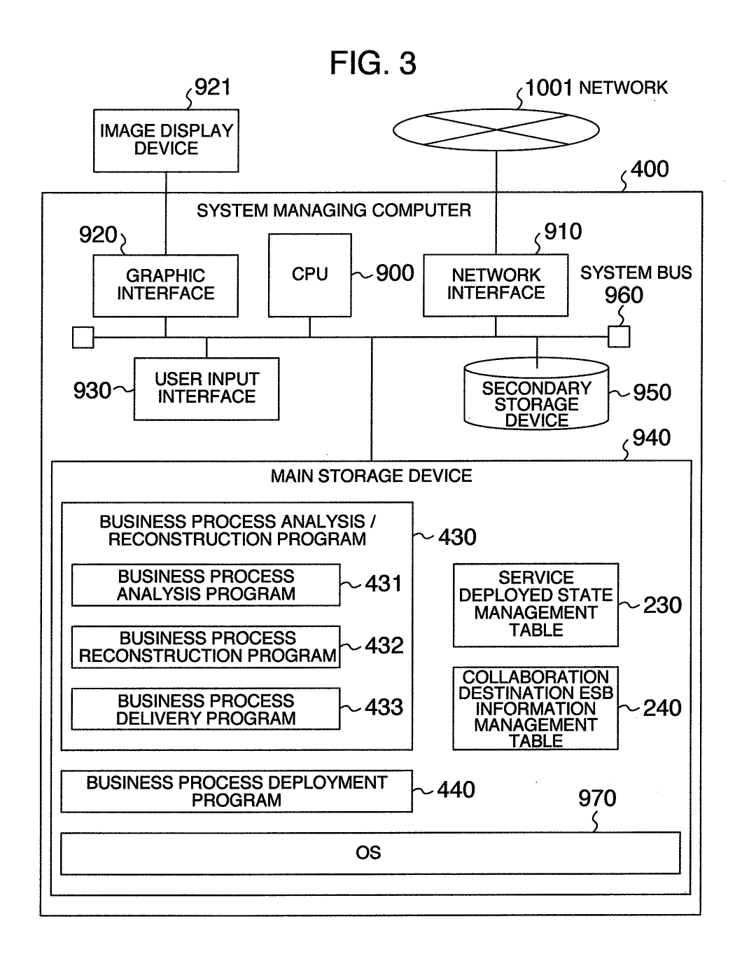

The business process analysis/reconstruction processing portion 410 is comprised of a business process analysis portion 411 which obtains information from the service deployed state management table 230 which keeps information with the service name and the service deployment destination ESB name in association with each other and allocates a service optimum for execution of the individual activities constructing the business process based on the obtained information, a business process reconstruction portion 412 which executes reconstruction of the business process based on the deployed state on the ESB of the service allocated by the business process analysis portion 411, and a business process delivery portion 413 which obtains an address from the collaboration destination ESB information management table 240 and delivers a newly defined business process by the reconstruction of the business process to a collaboration destination ESB. In this embodiment, both the system managing computer 400 and the ESB execution computer 201 keep the service deployed state management table 230 and the collaboration destination ESB information management table 240 which have the same contents. Therefore, it may be configured such that these tables are present on one of the computers, and the other computer refers to the tables. And, it is determined in this embodiment that the individual processing portions 410, 411, 412, 413 are realized as software, which are executed by a CPU 900, such as a business process analysis/reconstruction program 430, a business process analysis program 431, a business process reconstruction program 432 and a business process delivery program 433 (see FIG. 3), but not limited to them and may be mounted as dedicated hardware such as a semiconductor circuit. For convenience of explanation, the programs having the individual processing portions installed will be described as an execution entity below, if necessary.

The business process deployment portion 420 is a processing portion having a function to manage the business process on the ESB, such as deployment of the business process on the ESB, its deletion from the ESB, and the like in accordance with the instruction from the system manager 810, and it is realized as software, which is executed by the CPU 900, in this embodiment but not limited to it and may be installed as dedicated hardware such as a semiconductor circuit. The deployment of the business process is an operation to have an executable state by registering the business process on the ESB. In other words, after the above operation, the business process can be called from the client computers 701 to 703 (see FIG. 1). The call of the business process indicates an operation to transmit the execution request of the business process by using information capable of specifying the business process, such as a business process name, and input information to the business process and to obtain the execution results of the business process if necessary. The business process deployment portion 420 may have a function to automatically deploy the business process without receiving an instruction from the system manager 810 when the business process is input. Since the business process deployment portion 420 can be realized by a program having a general-purpose business process deployment function, its detailed description is omitted.

In this embodiment, the client computer 701 is comprised of a general-purpose computer such as a personal computer and a service calling board 710 which is executed on it as shown in FIG. 2. A client 820 can use the service by transmitting a service execution request to the ESB by using the service calling board 710. Since the service calling board 710 can be realized by using various types of program languages, detailed description of its realization method is omitted, but the service calling board 710 may be mounted as dedicated hardware such as a semiconductor circuit. It is assumed in this embodiment that the service calling board 710 is realized as software.

In this embodiment, service execution computers 501, 502 are comprised of a general-purpose computer such as a personal computer and a service execution board 510 which is a server program for execution of a service to be executed on it as shown in FIG. 2. Since the service can be installed by various types of component models and the service execution board 510 can be realized by various types of programs for execution of the mounted components, detailed description of its realization method is omitted. The service and the service execution board 510 may be realized as dedicated hardware such as a semiconductor circuit, but it is assumed in this embodiment that it is installed as a program.

For additional detailed description of the structure of the computer used in this embodiment, the structure of the system managing computer 400 is shown in FIG. 3.

In this embodiment, the system managing computer 400 is comprised of the CPU (Central Processing Unit) 900 as a processing portion, a network interface 910, a graphic interface 920, a user input interface 930, a main storage device 940 as a storage portion, a secondary storage device 950, and a system bus 960 for connecting them as shown in FIG. 3. The network interface 910 communicates with the ESB execution computer (see FIG. 1) and the business process development computer 300 (see FIG. 1), which are determined to be communicable mutually over the network 1001, in accordance with the instruction from the CPU 900.

The user input interface 930 has a function to receive input by the user from an input device such as a mouse and a keyboard. The graphic interface 920 processes an image shown on an image display device 921 such as a display but is not an essential device. The main storage device 940 stores the business process analysis/reconstruction program 430 (including the business process analysis program 431, the business process reconstruction program 432 and the business process delivery program 433), a business process deployment program 440 and an OS (Operating System) 970, and these programs are executed by the CPU 900. The main storage device 940 stores the service deployed state management table 230 and the collaboration destination ESB information management table 240, but these tables may be included in the business process analysis/reconstruction program 430 or stored in the secondary storage device 950. The secondary storage device 950 inputs and outputs data according to the instruction from the CPU 900. The main storage device 940 is a volatile storage device such as a memory, and the secondary storage device 950 is a non-volatile storage device including a magnetic storage device such as a hard disk, an optical storage device such as a CD (Compact Disc) or DVD (Digital Versatile Disk) drives but not limited to them.

The ESB execution computers 201 to 203 (see FIG. 1), the business process development computer 300 (see FIG. 1), the service execution computers 501 to 506 (see FIG. 1), and the client computers 701 to 703 (see FIG. 1) have the same hardware structure as that of the system managing computer 400 shown in FIG. 3. Differences from the system managing computer 400 are programs and tables which are deployed on the main storage device 940 and executed by the CPU 900. In the ESB execution computers 201 to 203, the OS 970 and the ESB 210 (see FIG. 2), the service deployed state management table 230 (see FIG. 2), the collaboration destination ESB information management table 240 (see FIG. 2) and the provided service list management table 250 (see FIG. 2) are deployed on the main storage device 940. But, the service deployed state management table 230 (see FIG. 2), the collaboration destination ESB information management table 240 (see FIG. 2) and the provided service list management table 250 (see FIG. 2) may be included in the ESB 210 (se FIG. 2) or may be stored in the secondary storage device 950. In the business process development computer 300 (see FIG. 2), the OS 970 and the business process developing function 310 (see FIG. 2) and the provided service list management table 250 (see FIG. 2) are deployed on the main storage device 940. The provided service list management table 250 (see FIG. 2) may be included in the business process developing function 310 (see FIG. 2) or may be stored in the secondary storage device 950. In the service execution computers 501 to 506, the OS 970 and the service execution board 510 (see FIG. 2), and the service which is deployed on the service execution board 510 (see FIG. 2) are deployed on the main storage device 940. In the client computers 701 to 703, the OS 970 and the service calling board 710 (see FIG. 2) are deployed on the main storage device 940.

FIG. 4 is a diagram showing a structure of the collaboration destination ESB information management table of this embodiment. As shown in FIG. 4, the collaboration destination ESB information management table 240 is comprised of a column of ESB name 241 for storing ESB names and a column of address 242 for storing ESB addresses. It is sufficient as long as the ESB name 241 includes information capable of specifying the ESB and the address 242 includes address information of the ESB, and they are not limited to the name and IP address.

FIGS. 5A and 5B are diagrams showing structures of service deployed state management tables 230 according to the embodiment, FIG. 5A shows a state before the registration of a newly defined business process, and FIG. 5B shows a state after the registration of a newly defined business process by the business process reconstruction of the invention. As shown in FIG. 5A, the service deployed state management table 230 is comprised of a column of service name 231 for storing service names and a column of deployment destination ESB name 232 for storing service deployment destination ESB names. Information to be stored in the individual columns is sufficient as long as it can specify the service or the ESB and not limited to the name. As shown in FIG. 5B, newly defined business processes (e.g., a service BB and a service CC) are registered in the service deployed state management table 230 by a business process delivery program 433. The business process is included in the service.

FIGS. 6A and 6B are diagrams showing structures of provided service list management tables 250 according to the embodiment, FIG. 6A shows a state before the registration of newly defined business processes, and FIG. 6B shows a state after the registration of newly defined business processes by the business process reconstruction of the invention. As shown in FIG. 6A, the provided service list management table 250 is comprised of a column of service name 251 for storing service names and a column of service overview 252 for storing service overview. In this embodiment, the service names are stored in the column of service name 251, but information to be stored in the service name 251 is sufficient as long as it can specify the service and not limited to the service names. Here, the service overview means information about the function provided by the service and interface information such as an input/output message format. As shown in FIG. 6B, newly defined business processes (e.g., a service BB and a service CC) are stored in the provided service list management table 250 by the business process delivery program 433.

Embodiments of the invention are described below in further detail according to the procedures of the embodiments.

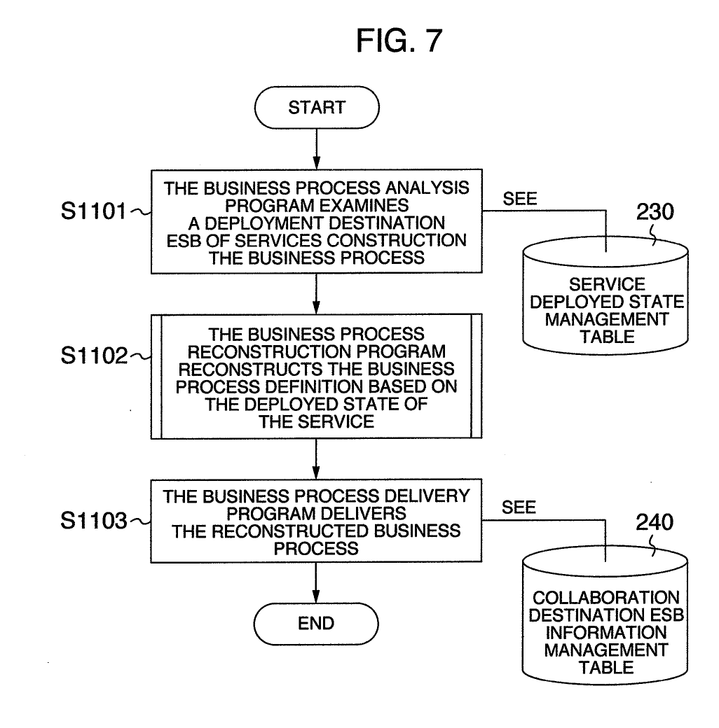

FIG. 7 shows a flow of an implementing procedure of the embodiment. The procedure of this embodiment is described with reference to FIG. 7 (see FIG. 1 to FIG. 6, if necessary).

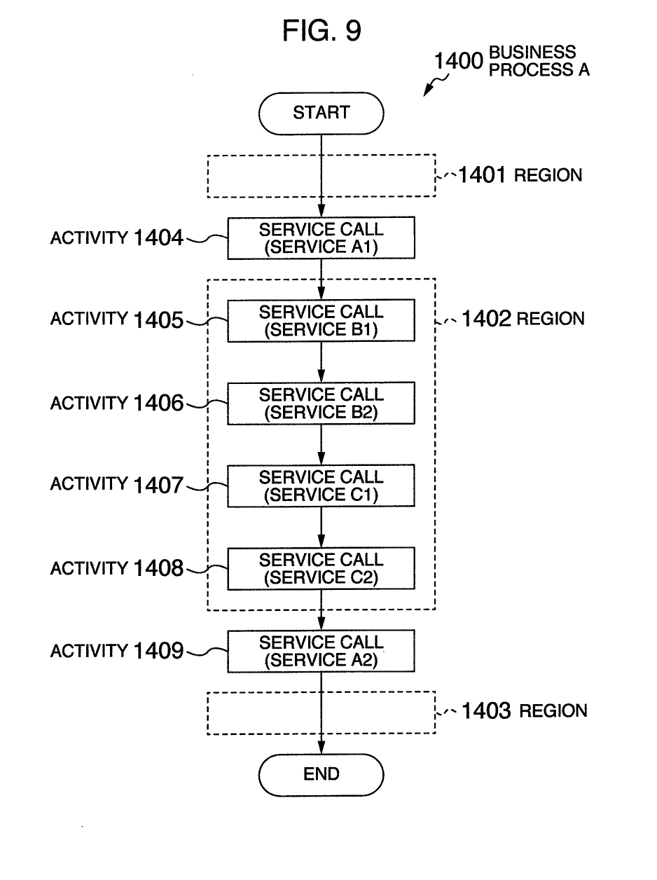

First, the business process developer 800 uses the business process developing function 310 which is executed on the business process development computer 300 to define the business process. At this time, the business process developing function 310 obtains the service list information, which can be used for the business process definition, from the provided service list management table 250 and presents it to the business process developer 800. The data presented by the business process developing function 310 may be all or part of the data which is registered in the provided service list management table 250. The business process developer 800 combines the presented services to define the business process. As shown in FIG. 6A, the provided service list management table 250 is comprised of the service name 251 and the service overview 252, and the business process developer 800 can define the business process without being conscious of the detailed system configurations of the SOA systems A, B, C. It is assumed in this embodiment that a business process A (1400) shown in FIG. 9 is defined by the business process developer 800. The business process A (1400) defines that the service A1 (601), the service B1 (605), the service B2 (606), the service C1 (607), the service C2 (608) and the service A2 (602) are executed in the above-described order.

Then, the system manager 810 grasps the business process definition information which is defined by the business process developer 800 upon receiving a notice from the business process developer 800 by means such as mail. And, the system manager 810 inputs the definition information about the business process, which is grasped according to the notice, to the business process analysis/reconstruction program 430. The business process analysis/reconstruction program 430 is comprised of the business process analysis program 431, the business process reconstruction program 432 and the business process delivery program 433 and performs a processing in the above-described order.

The business process analysis program 431 examines a deployment destination ESB of each service constructing the business process (step S1101). In other words, the business process analysis program 431 analyzes the business process definition information input from the system manager 810 and allocates a service appropriate for execution of the activity to the individual activities constructing the business process. At this time, the business process analysis program 431 uses the service name 231 as a key to search the service deployed state management table 230 and allocates the service of the service name 231 deployed on the ESB of the deployment destination ESB name 232 obtained as a result of the search as a service for executing the activity. Here, in a case where plural deployment destination ESB names 232 having the same service name 231 are searched for from the service deployed state management table 230, the service may be allocated by using additional information, such as selecting a service having the shortest execution time with reference to a service execution history (not shown), and selecting a service which is executed on a computer which has the largest allowance in resource judged by collecting metric information of the service execution computer. Such a service allocation method is published by the above-described US 2005/0149367A1 and the like. The activities other than the activity for calling the service are not required to allocate the service.

The business process reconstruction program 432 reconstructs business process definition based on the deployed state of the service (step S1102). In other words, the business process reconstruction program 432 reconstructs a business process by having, as input, definition information of the business process defined by the business process developer 800 and deployment information which is a combination of information capable of specifying the services(such as the service name 231) allocated to the individual activities in the step S1101 and deployment destination information (such as the deployment destination ESB names 232) having a service deployed (step S1102). The business process reconstruction algorithm applied in this step is described later.

The business process delivery program 433 delivers the business process newly defined by the reconstruction of the business process performed in the step S1102 to the ESB which will execute the business process (step S1103). The delivery is made through the network 1001, the ESB execution computer 201 and the network 1000. The address of the delivery destination ESB can be obtained by searching the collaboration destination ESB information management table 240 with the delivery destination ESB name 241 used as a key. The business process delivery program 433 may have a function that, before the delivery, it obtains the service name 231 of the service which is deployed on the delivery destination ESB from the service deployed state management table 230 with the deployment destination ESB name 232 used as a key, obtains the service overview 252 of the service designated by the obtained service name 231 from the provided service list management table 250 with the service name 251 used as a key, and checks whether the service (business process) for executing the same function as that of the business process to be delivered is already deployed on the delivery destination ESB. When the above function is used and the service (business process) having the same function is present, a new business process is not delivered, but the definition of the business process is changed to use the already defined service (business process), so that plural services (business processes) having the same function can be made not to be deployed on the same ESB. And, the business process delivery program 433 delivers the newly defined business process to the ESB for executing the business process and also registers data into the service deployed state management table 230 and the provided service list management table 250. For registration of the data, the business process delivery program 433 registers information capable of specifying the newly defined business process and the ESB for executing the business process as, for example, the service name 231 and the deployment destination ESB name 232 into the service deployed state management table 230, and registers information capable of specifying the newly defined business process and the business process overview as, for example, the service name 251 and the service overview 252 into the provided service list management table 250.

After the execution of the business process analysis/reconstruction program 430 is terminated, the system manager 810 uses the business process deployment program 440 to deploy the business process delivered in the step S1103 to the ESB. In the above-described procedure, the business process delivered in the step S1103 is manually deployed by the system manager 810, but when the business process deployment program 440 has a function to automatically deploy the business process to the ESB, the delivered business process may be deployed automatically.

The business process reconstruction algorithm which is executed in the step S1102 is described below.

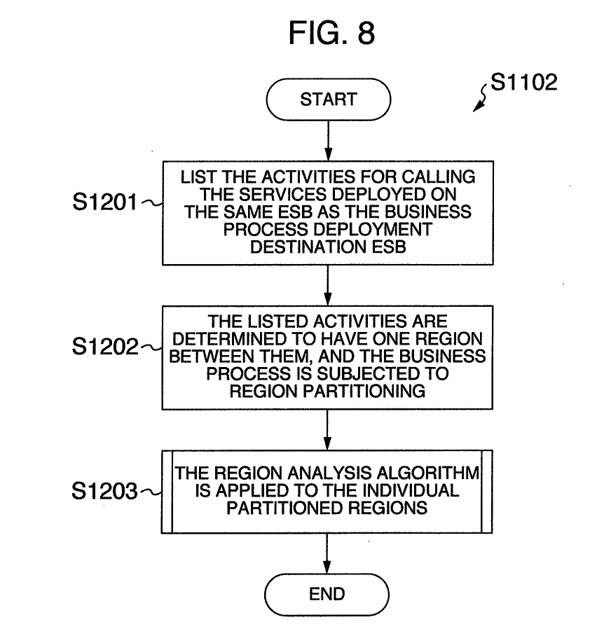

The business process reconstruction algorithm is an algorithm to reconstruct a business process so as to decrease the number of times of inter-ESB collaboration by using deployment destination ESB information (deployment destination ESB name) of the service which is allocated to the activity constructing the business process, and it is executed by the business process reconstruction program 432. FIG. 8 shows a processing flow of the business process reconstruction algorithm. The business process reconstruction algorithm is described below with reference to FIG. 8 (see FIG. 1 to FIG. 6, if necessary).

First, the results of allocation of the services to the activities constructing the business process performed in the step S1101 are used to list the activities which call one of the services deployed on the same ESB as the business process deployment destination ESB (step S1201). FIG. 9 is a diagram showing an example of the business process which is deployed on an ESB-A (210). For example, in an example of the business process A (1400) shown in FIG. 9, an activity 1404 and an activity 1409 which call services, such as a service A1 and a service A2, deployed on the ESB-A (210) which is a deployment destination ESB of the business process A (1400) are listed. Here, the business process A (1400) is input by the system manager 810 into the system managing computer 400 of the SOA system A (101), so that the ESB-A (210) of the ESB execution computer 201 belonging to the SOA system A (101) (communicatable with the system managing computer 400 over the network 1001) which is the same SOA system as that of the system managing computer 400 is a deployment destination ESB of the business process A (1400). But, as a result of the reconstruction of the business process A (1400), an ESB execution computer which becomes a deployment destination of a newly defined business process is decided by the processing described later.

The activities listed in the step S1201 are determined to have one region between them, and the business process is subjected to region partitioning (step S1202). Here, the region indicates a part of the business process including zero or more of successive activities defined on the business process. For example, in the business process A (1400) shown in FIG. 9, the region partitioning is performed to determine that one region 1401 is up to the activity 1404, one region 1402 is between the activity 1404 and the activity 1409, and one region 1403 is from the activity 1409. There is a case where no service is included in the region such as the region 1401 and the region 1403.

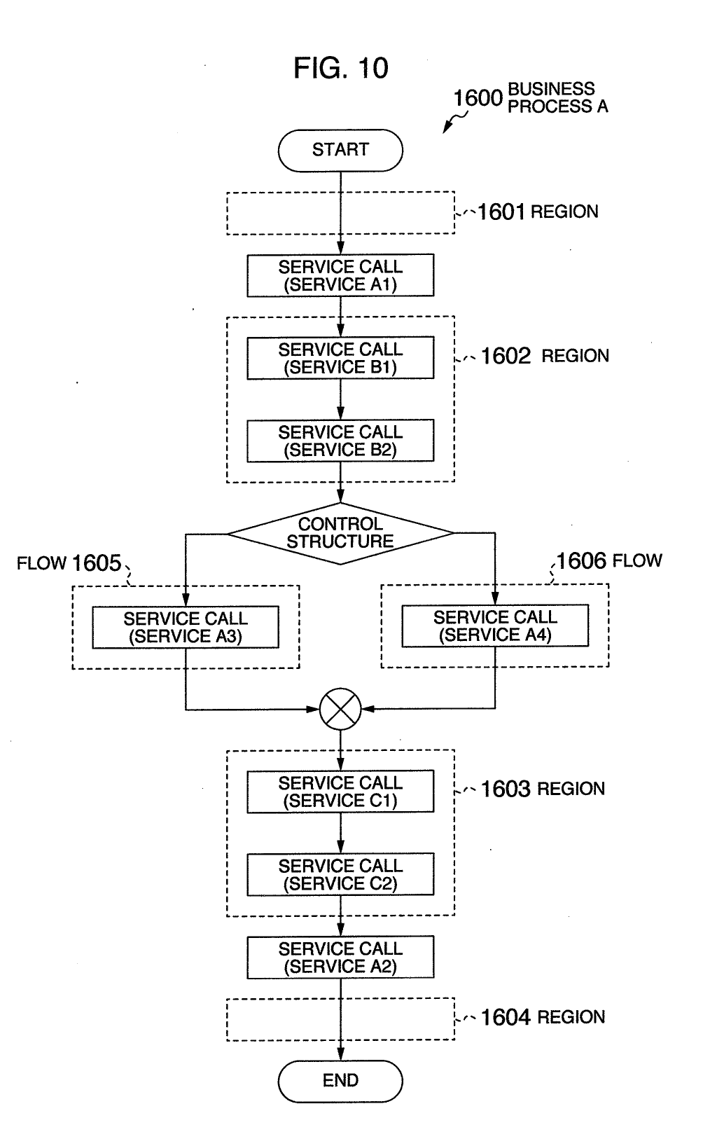

Here, where the business process includes a control structure, the region partitioning of the business process is also performed before and after the control structure. An example of the business process including the control structure is shown in FIG. 10. Here, the control structure represents the activity which performs the flow control of the business process, and its examples include a branch processing and a parallel processing. The branch processing is a control structure for selection (control) of a flow to execute the business process according to data (such as the stock quantity if the stock management service is received) input by the client 820 or the state of the service (such as the executed result of the service). In the example of FIG. 10, where the control structure is the branch processing, the business process is defined such that a service A3 is executed if certain conditions are satisfied but a service A4 is executed if the conditions are not satisfied. And, the parallel processing is a control structure to perform plural processing flows in parallel. In the example of FIG. 10, where the control structure is a parallel processing, the business process is defined such that it is possible to perform the service A3 and the service A4 in parallel after the execution of a service B2, and a service C1 is executed after the processing of both the service A3 and the service A4 is completed.

In the example shown in FIG. 10, the region partitioning is performed to determine that one region 1601 is up to a service A1, one region 1602 is between the service A1 and the start of the control structure, one region 1603 is between the completion of the control structure and a service A2, and one region 1604 is from the service A2. If the business process includes a control structure, one or plural flows are defined within the control structure. The example of FIG. 10 shows that two flows are described. For the flow within the control structures, the business process reconstruction algorithm is executed recursively. In the example of FIG. 10, a flow 1605 and a flow 1606 are present as flows within the control structure, and for the flows, the business process reconstruction algorithm is executed recursively.

As described above, the region partitioning of the business process including the control structure is executed recursively, and the finally divided regions do not include the control structure but can be configured of only the activities for calling the service.

This embodiment describes about a reconstruction method of a business process not including a control structure but does not limit the reconstruction of the business process including the control structure.

The region analysis algorithm is applied to the individual regions divided in the step S1202 (step S1203). Details of the region analysis algorithm are described later.

When a new business process is defined in the step S1203, it is desirable that the steps S1201 to S1203 are applied recursively to all the newly defined business processes. If a new business process is not defined in the step S1203, the algorithm is terminated.

The region analysis algorithm executed in the step S1203 is described below. The region analysis algorithm is an algorithm to define the activity included in the region as a new business process and executed by the business process reconstruction program 432.

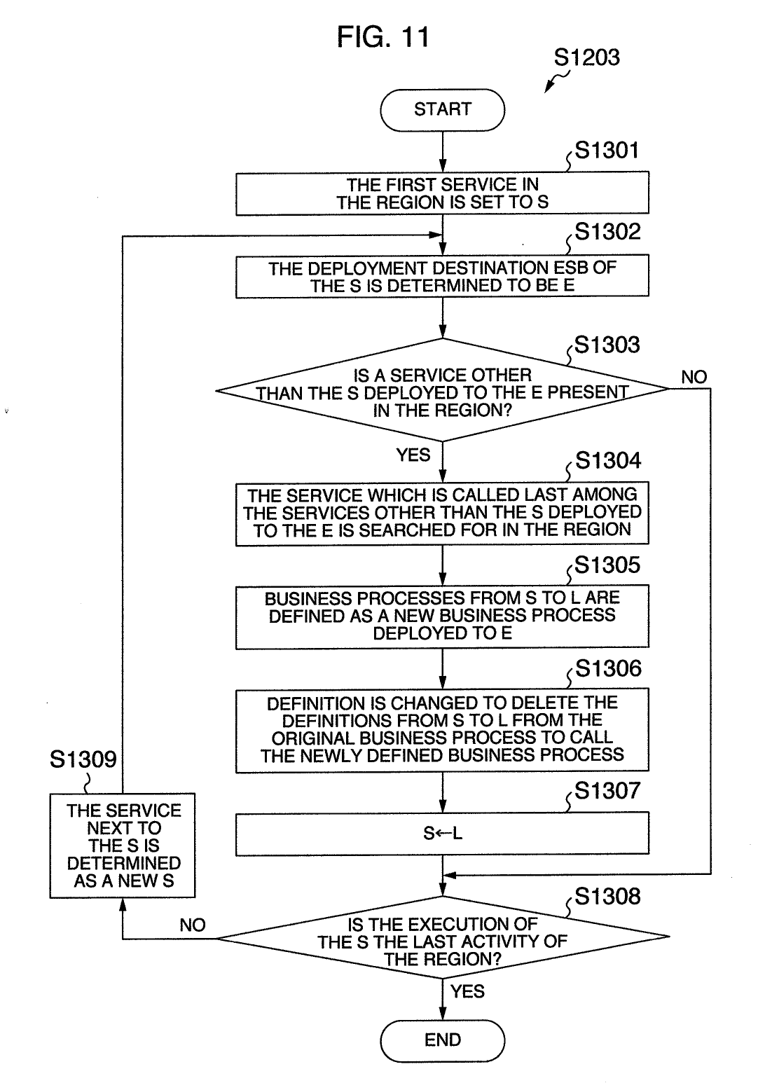

FIG. 11 shows a processing flow of the region analysis algorithm.

First, the first service in the region is set to S (step S1301). In other words, the service which is called by the first activity in the region is obtained and set to S. In the example of the region 1402 shown in FIG. 9, service B1 which is called by the activity 1405 which is the first activity of the region 1402 is set to S.

Then, the business process reconstruction program 432 checks the deployment destination ESB of the service allocated to the S. In other words, the business process reconstruction program 432 determines the deployment destination ESB of the S as E (step S1302). In the example of the region 1402 shown in FIG. 9, it is confirmed that the deployment destination ESB of the service B1 is ESB-B. The deployment destination ESB has been obtained in the step S1101.

Subsequently, it is checked whether there is an activity to which the service deployed to E is allocated is present in the region. In other words, it is judged whether a service other than the S deployed to the E is present in the region (step S1303). In the example of the region 1402 shown in FIG. 9, there is an activity 1406 to which the service B2 is allocated. In other words, it is confirmed that the service B2 other than the S deployed to the E is present in the region 1402.

If there is no other activity, namely, if there is no service other than the S deployed to the E in the region (“No” in step S1303), the procedure proceeds to step S1308.

If there is one or plural activities, namely, if there is a service other than the S deployed to the E in the region (“Yes” in step S1303), the service which is called last among the services other than the S deployed to the E is searched for in the region and set to L (step S1304). In the example of the region 1402 shown in FIG. 9, the service B2 is selected.

Then, the business process definitions from the S to the L are defined as a new business process to deploy to the E (step S1305). A business process partitioning algorithm to cut out some business processes from the input business processes to define as new business processes will be described later.

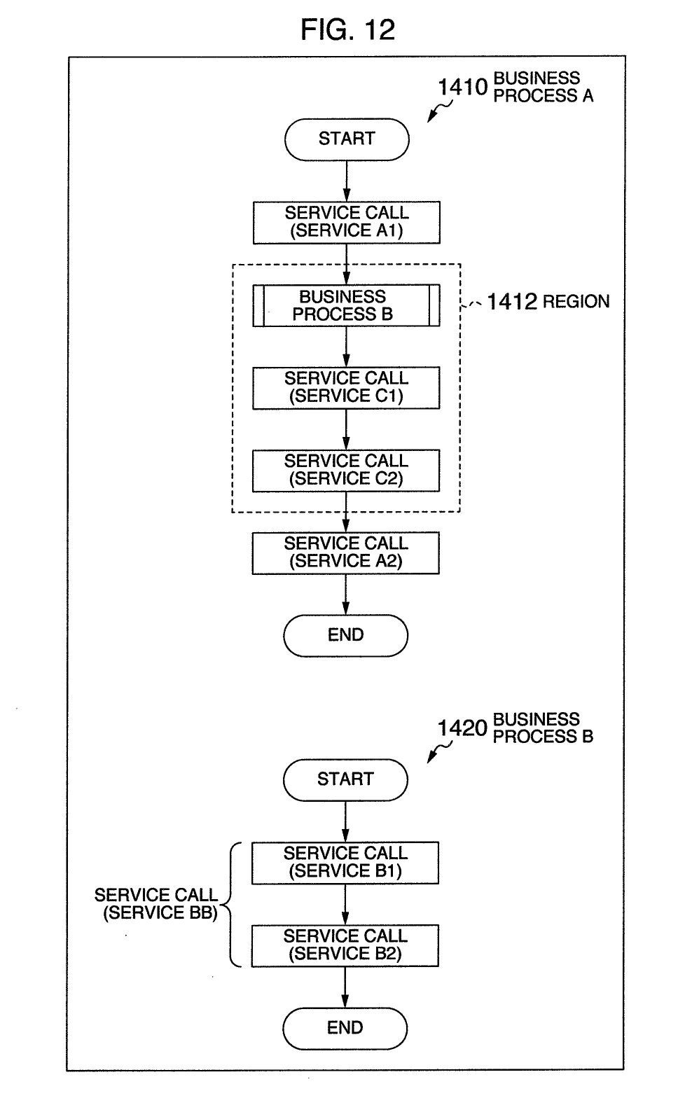

Definition is changed to delete the definitions from the S to the L from the original business process so as to call the newly defined business process (step S1306). The activity 1405 and the activity 1406 are cut out from the business process A (1400) shown in FIG. 9 and redefined as new business process. The results are shown in FIG. 12. The business process A (1410) shown in FIG. 12 is defined that a service A1 is executed, then a business process B (1420) is executed, and a service C1, a service C2 and a service A2 are executed. Here, the business process B (1420) is defined to sequentially execute the service B1 and the service B2, so that when the business process A (1410) is executed, the service A1, the service B1, the service B2, the service C1, the service C2 and the service A2 are executed in this order, so that the same service execution procedure as that of the business process A (1400) which is a business process prior to the partitioning is defined. Here, the combination of the services executed in order of the service B1 and the service B2 are denoted by a service BB.

After the execution of the step S1306, the L is set as new S (step S1307), and the procedure proceeds to the step S1308.

Subsequently, it is judged whether the execution of the S is the last activity in the region. In other words, it is judged whether the S is the last service in the region (step S1308). If the S is the last service (“Yes” in step S1308), the algorithm is terminated.

If the S is not the last service, the service next to the S is determined as a new S (step S1309), and the procedure returns to the step S1302.

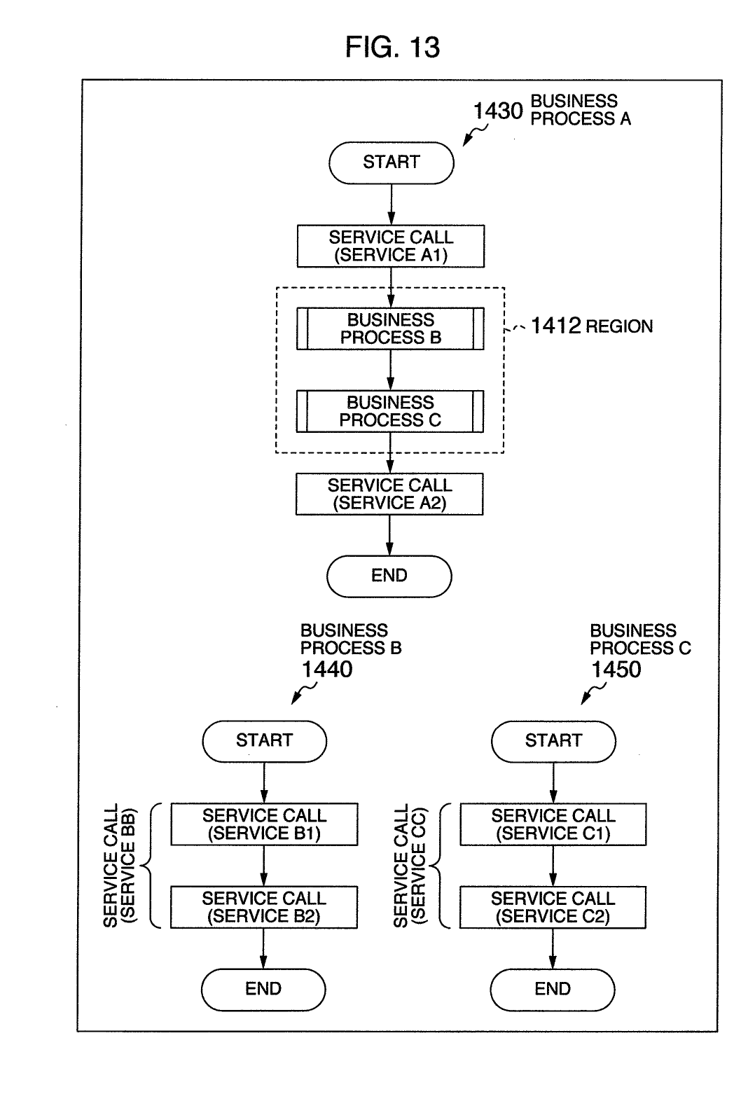

In the business process A (1400) shown in FIG. 9, the activity 1407 and the activity 1408 are included in the region 1402, so that the service C1 executed by the activity 1407 is determined as a new S, and the procedure returns to the step S1302. The results obtained by executing the algorithm with the service C1 executed by the activity 1407 determined as the S are shown in FIG. 13. FIG. 13 shows that a business process C (1450) which sequentially executes a service C1 and a service C2 is newly defined, and is called from the business process A (1430). And, the combination of the services executed in order of the service C1 and service C2 is denoted by a service CC.

The business process partitioning algorithm to be applied in the step S1305 is described below. The business process partitioning algorithm is executed by the business process reconstruction program 432.

In a case where the business process(called original business process hereafter) is partitioned into plural business processes, the definition may be changed such that a new business process having the same definition as the service calling to partition from the original business process is defined and a newly defined business process is called from the original business process. But, if the original business process has had a variable declaration, the original business process is partitioned by the following method.

The variable in the business process is a region for storing a message instance to be used by the activities constructing the business process and can be used for an input/output message to call a service, the branch conditions of the branch processing or the like.

In a case where the business process having defined the variable is partitioned, it is also necessary that the partitioned business process can use the same variable as the original business process to be partitioned. Therefore, the partitioned business process is defined to have the same variable definition as the variable definition defined by the original business process. The value of the variable defined for the partitioned business process makes it possible to allocate a value by sending the value of the variable as a part of the message when the partitioned business process is called. And, to transmit the value of the variable after the execution of the partitioned business process to the original business process, the state of the variable is added to the message which is transmitted from the partitioned business process to the original business process.

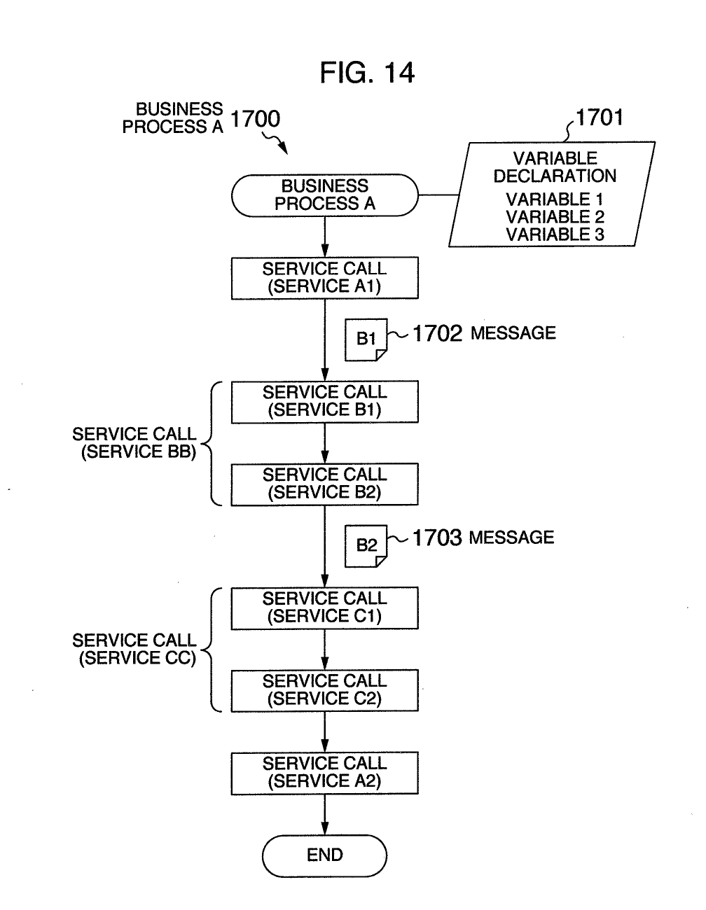

As an example of the business process having defined a variable, a business process A (1700) is shown in FIG. 14. It is assumed that the business process A (1700) is deployed on ESB-A. In the business process A (1700), a variable 1, a variable 2 and a variable 3 are declared as variables as indicated by a variable declaration 1701. The example shown in FIG. 14 uses a message B1 (1702) as an input message format of the service B1 and a message B2 (1703) as an output message format of the service B2.

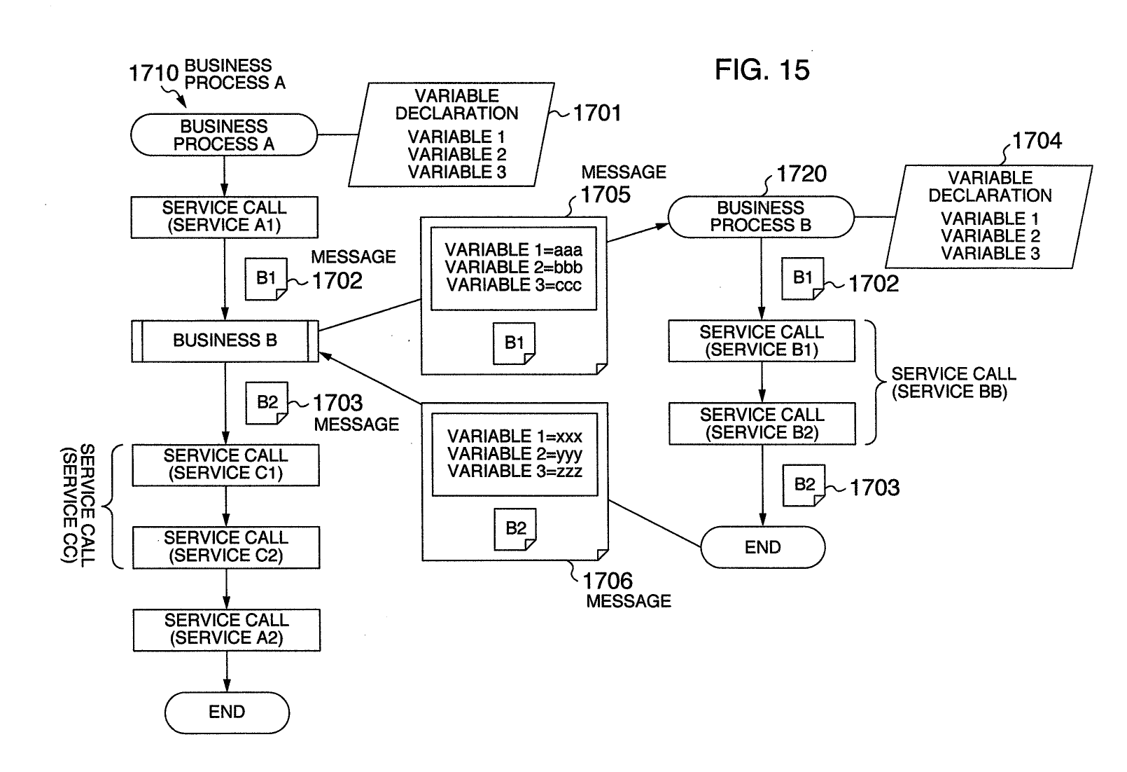

The results of reconstruction of the business process A (1700) by the business process analysis/reconstruction program 430 are shown in FIG. 15. In FIG. 15, a business process B (1720) which calls the service B1 and the service B2 which are services deployed on ESB-B is newly defined and called from the business process A (1710). Here, a variable declaration 1704 is defined to the business process B (1720) in the same manner as the business process A (1700). In addition, to call the business process B (1720) from the business process A (1710), a message 1705 for sending the value of the variable is sent in addition to the message B1 (1702) which is an input message format of the service B1, and to reply from the business process B (1720) to the business process A (1710), a message 1706 for sending the value of the variable after the execution of the business process B (1720) is sent in addition to the message B2 (1703) which is an output message format of the service B2.

Where the business process including a variable is partitioned as described above, the same variable declaration as that of the original business process is executed for the partitioned business process, and the value of the variable is added to the input/output message of the partitioned business process, thereby enabling to perform the partitioning.

In the example of FIG. 15, all the variables defined by the original business process are defined to the partitioned business process, but only the variables used by the partitioned business process may be defined.

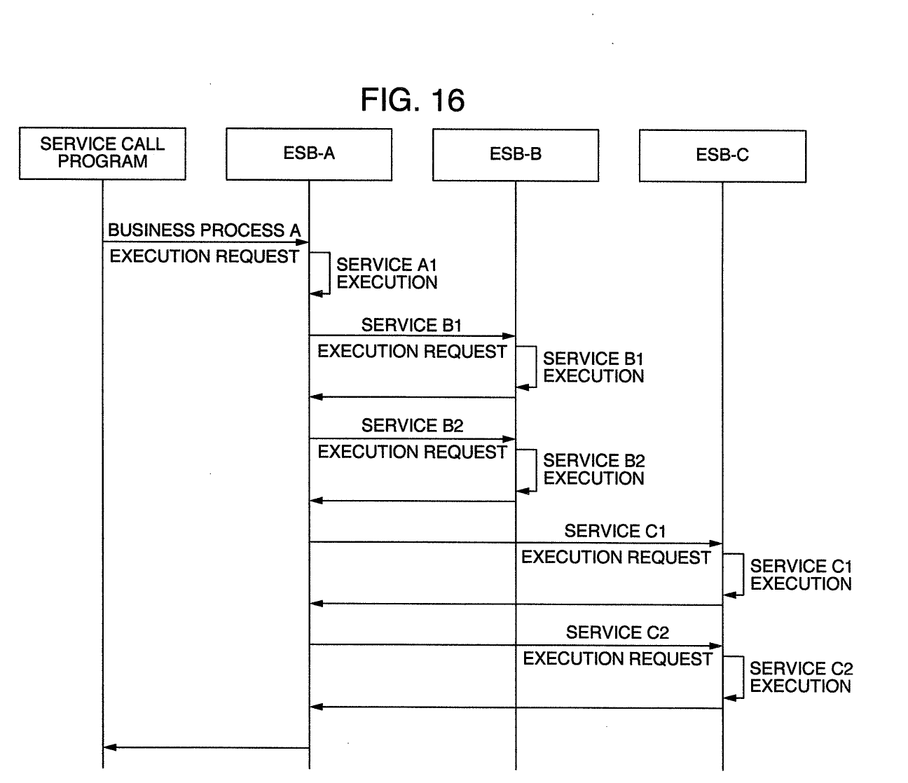

As described above, in the step S1102, the system managing computer 400 extracts from business process definition information a combination of plural successive services which can be executed by the ESB execution computer belonging to the SOA system different from the SOA system which contains the system managing computer 400 storing the business process analysis/reconstruction program 430 in which the definition information of the business process is input. And, the system managing computer 400 defines the combination of the extracted services as a new business process which is deployed to the ESB execution computer belonging to an SOA system different from the above-described system managing computer 400, and reconstructs the original business process as a business process for calling the new business process. The effects obtained by applying the reconstruction of the business process according to this embodiment to the business process A (1400) (see FIG. 9) defined by the business process developer 800 are described below. FIG. 16 shows a sequence diagram that the business process A (1400) (see FIG. 9) defined by the business process developer 800 is executed as it is without performing the reconstruction of the business process according to this embodiment. As shown in FIG. 16, to execute the business process A (1400), when the individual services such as a service B1, a service B2, a service C1 and a service C2 are executed, collaboration for execution of the service is performed between ESB-A and ESB-B, between ESB-A and ESB-B, between ESB-A and ESB-C and between ESB-A and ESB-C. Thus, the collaboration is performed a total of four times.

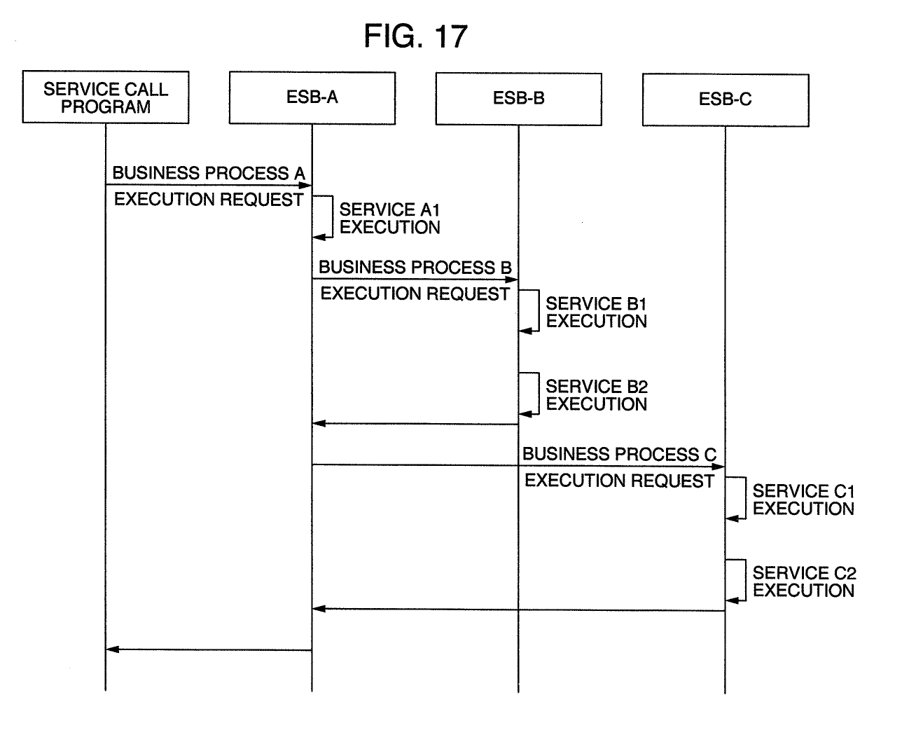

Meanwhile, a sequence diagram when the business process A (1430) (see FIG. 13) which is a business process resulting from the application of reconstruction of the business process according to this embodiment to the business process A (1400) is executed is shown in FIG. 17. As shown in FIG. 17, by the business process A (1430) (see FIG. 13) resulting from the application of the reconstruction of the business process according to this embodiment, a business process B (1440) (see FIG. 13) which successively executes a service B1 and a service B2 and a business process C (1450) (see FIG. 13) which successively executes a service C1 and a service C2 are defined, and called from the business process A (1430) (see FIG. 13). Therefore, inter-ESB collaboration required when the business process A (1430) (see FIG. 13) is executed is decreased to two times. Therefore, inefficient inter-ESB collaboration which is performed when the business process is executed is decreased by the reconstruction of the business process according to this embodiment. And, since the number of times of the inter-ESB collaboration required when the business process is executed is decreased, the improvement of throughput of the ESB execution computer by reduction of a calculation amount of the ESB execution computer required for execution of the business process and the effect of the lowering of communications traffic over the network can be obtained.

Then, a second embodiment is described with reference to the drawings.

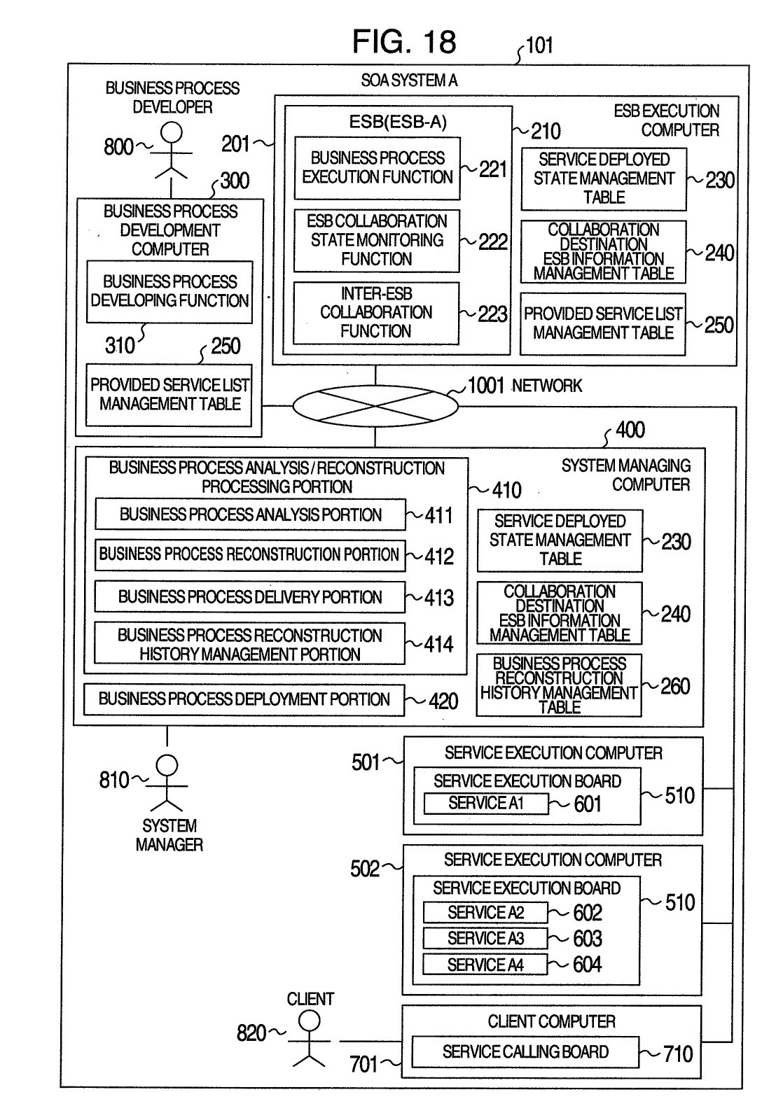

An example of the SOA system according to the second embodiment is shown in FIG. 18. Differences from the SOA system according to the first embodiment shown in FIG. 2 include that the business process analysis/reconstruction portion 410 has a business process reconstruction history management portion 414, and the system managing computer 400 has a business process reconstruction history management table 260.

The business process reconstruction history management table 260 is stored in the main storage device 940 of the system managing computer 400 (see FIG. 3). But, the business process reconstruction history management table 260 may be included in the business process analysis/reconstruction processing portion 410 and may be stored in the secondary storage device 950 (see FIG. 3).

The business process reconstruction history management portion 414 can be installed as software, which is stored in the main storage device 940 (see FIG. 3) of the system managing computer 400 and executed by the CPU 900 (see FIG. 3), but is not limited to it and may be mounted as dedicated hardware such as a semiconductor circuit. The business process reconstruction history management portion 414 has a function to manage, by using the business process reconstruction history management table 260, history information for associating the business process before the execution of the reconstruction with the business process after the execution of the reconstruction for the business process reconstructed by using the business process analysis/reconstruction processing portion 410. It is assumed in this embodiment that the business process reconstruction history management portion 414 is realized as software which is executed by the CPU 900, but for convenience of explanation, the business process reconstruction history management portion 414 is described as an execution entity, if necessary.

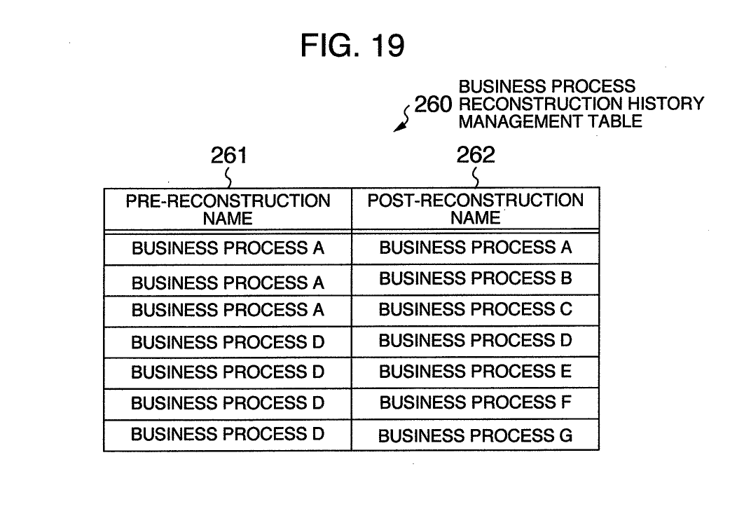

A structure of the business process reconstruction history management table 260 is shown in FIG. 19. The business process reconstruction history management table 260 is comprised of a pre-reconstruction name 261 which is a column for storing pre-reconstruction business process names, and a post-reconstruction name 262 which is a column for storing post-reconstruction business process names, and the business process reconstruction history management portion 414 stores information with the pre-reconstruction business process name and the post-reconstruction business process name in association with each other. In other words, the business process having the same pre-reconstruction business process name indicates a business process obtained as a result of reconstruction of the entirely same business process. For example, the example shown in FIG. 19 shows that the reconstruction of the business process A defined by the business process developer 800 has resulted in the reconstruction of three business processes of the business process A, the business process B and the business process C. Similarly, it is shown that the reconstruction of the business process D has resulted in reconstruction of four business processes of a business process D, a business process E, a business process F and a business process G. Information for associating the business processes may be information capable of specifying the business processes and not limited to the names of the business processes.

It is assumed in this embodiment that the business process deployment portion 420 has a function to associate the pre-reconstruction business process with the post-reconstruction business process by using information stored in the business process reconstruction history management table 260. By the above function, the system manager 810 can use the definition information of the pre-reconstruction business process to perform operations such as deployment and deletion of the business process to and from the ESB, a change in the definition of the business process, and the like. Thus, the system manager 810 can perform the operations of the business process in the same manner as a case where the reconstruction is not performed even if the business process is partitioned into plural business processes by performing the reconstruction of the business process.

To store the reconstruction results of the business process, the business process reconstruction history management portion 414 searches the business process reconstruction history management table 260 with the business process name used as a key in order to examine whether the reconstructed business process has been defined. If the business process has been defined newly (there is not a pre-reconstruction name 261 which agrees with the business process name to be registered), the business process reconstruction history management portion 414 stores information into the business process reconstruction history management table 260 as new associating information. If a business process having the same name as the reconstructed business process has been defined (if there is a pre-reconstruction name 261 which agrees with a business process name to be registered), it indicates that the definition of the business process is changed. Therefore, the information (data that the pre-reconstruction name 261 agrees with the business process name to be registered) already present in the business process reconstruction history management table 260 is deleted, and the associating information is stored newly. Thus, the business process developer 800 can change the definition of the business process by using the definition information of the pre-reconstruction business process regardless of whether or not the business process has been reconstructed.

According to this embodiment, a calculation amount of the ESB required when the business process is executed can be decreased, and throughput of the ESB can be improved by reconstructing the business process and decreasing the number of times of collaboration between ESBs at the time of execution of the business process. In addition, it becomes possible to decrease a network load by virtue of the reduction of the number of times of communications between the ESBs and to improve the response time when the business process is executed.

According to the present invention, it becomes possible to solve a problem that it is necessary to reduce the inefficient inter-ESB collaboration which is performed when the business process is executed in the system that the service is provided by the collaboration of plural ESBs.

It should be further understood by those skilled in the art that although the foregoing description has been made on embodiments of the invention, the invention is not limited thereto and various changes and modifications may be made without departing from the spirit of the invention and the scope of the appended claims.

1. A business process reconstruction method by a computer which is used for a business process management system that a business process processing unit of a subsystem having a single or plurality of computers communicable with the business process processing unit collaborates with a business process processing unit of a different single or plurality of subsystems over a network to perform a processing of a business process and which has a storage portion for storing deployment information having information capable of specifying services constructing the business process in correspondence with a business process processing unit having the deployed services and business process definition information having the business process defined, the method comprising the steps of:
extracting from the business process definition information a combination of a plurality of successive services executable by a business process processing unit different from a business process processing unit belonging to the same subsystem as the computer on the basis of the deployment information, and
defining the extracted combination of the services as a new business process which is deployed on the different business process processing unit, and reconstructing the business process as a business process for calling the new business process.

2. The business process reconstruction method according to claim 1, wherein the storage portion stores a name given to the service as information for specifying the service.

3. The business process reconstruction method according to claim 1, the method further comprising the step of: after reconstructing the business process, delivering the new business process to a business process processing unit which executes the new business process via the business process processing unit belonging to the same subsystem as the computer.

4. The business process reconstruction method according to claim 3, the method further comprising the step of: after delivering the new business process, deploying the new business process to the business process processing unit to which the new business process is delivered.

5. The business process reconstruction method according to claim 1, the method further comprising the step of: after reconstructing the business process, when a business process having the same function as the new business process is extracted by the business process processing unit which executes the new business process, changing the definition of the business process to use the extracted business process instead of the new business process.

6. The business process reconstruction method according to claim 1, the method further comprising the step of:
listing services, which are deployed on the business process processing unit belonging to the same subsystem as the computer, from the business process definition information based on the deployment information,
performing region partitioning of the business process with the listed services determined to have one region between them,
extracting from the business process definition information a combination of a plurality of successive services which are in the region and have the first service and last service therein executable by the same business process processing unit, and
defining the extracted combination of the services as a new business process which is deployed on the different business process processing unit.

7. The business process reconstruction method according to claim 1, the method further comprising the step of: when the business process includes a variable declaration, notifying the new business process of a value of the variable.

8. The business process reconstruction method according to claim 1, the method further comprising the steps of:
storing information associating a pre-reconstruction business process with a post-reconstruction business process into the storage portion, and
converting the processing having designated the pre-reconstruction business process into the processing having designated the post-reconstruction business process according to the associating information.

9. The business process reconstruction method according to claim 8, wherein the processing having designated the pre-reconstruction business process includes at least one among a processing for deploying the business process to the business process processing unit, a processing for deleting the business process from the business process processing unit and a processing for changing the definition of the business process.

10. A computer, which is used for a business process management system that a business process processing unit of a subsystem having a single or plurality of computers communicable with the business process processing unit collaborates with a business process processing unit of a different single or plurality of subsystems over a network to perform a processing of a business process, comprising:
a storage portion which stores deployment information having information capable of specifying services constructing the business process in correspondence with a business process processing unit having the deployed services and business process definition information having the business process defined, and
a processing portion which processes information, wherein the processing portion:
extracts from the business process definition information a combination of a plurality of successive services executable by a business process processing unit different from a business process processing unit belonging to the same subsystem as the computer on the basis of the deployment information, and
defines the extracted combination of the services as a new business process which is deployed on the different business process processing unit, and reconstructs the business process as a business process for calling the new business process.

11. The computer according to claim 10, wherein the storage portion stores a name given to the service as information for specifying the service.

12. The computer according to claim 10, wherein the processing portion having reconstructed the business process delivers the new business process to a business process processing unit which executes the new business process via the business process processing unit belonging to the same subsystem as the computer.

13. The computer according to claim 12, wherein the processing portion having delivered the new business process deploys the new business process to the business process processing unit to which the new business process is delivered.

14. The computer according to claim 10, wherein the processing portion having reconstructed the business process changes the definition of the business process to use the extracted business process instead of the new business process when a business process having the same function as the new business process is extracted by the business process processing unit which executes the new business process.

15. The computer according to claim 10, wherein the processing portion:
lists services, which are deployed on the business process processing unit belonging to the same subsystem as the computer, from the business process definition information based on the deployment information,
performs region partitioning of the business process with the listed services determined to have one region between them,
extracts from the business process definition information a combination of a plurality of successive services which are in the region and have the first service and last service therein executable by the same business process processing unit, and
defines the extracted combination of the services as a new business process which is deployed on the different business process processing unit.

16. The computer according to claim 10, wherein when the business process includes a variable declaration, the processing portion notifies the new business process of a value of the variable.

17. The computer according to claim 10, wherein:
the storage portion also stores information associating a pre-reconstruction business process with a post-reconstruction business process, and
the processing portion converts the processing having designated the pre-reconstruction business process into the processing having designated the post-reconstruction business process according to the associating information.

18. The computer according to claim 17, wherein the processing portion executes, as the processing having designated the pre-reconstruction business process, at least one among a processing for deploying the business process to the business process processing unit, a processing for deleting the business process from the business process processing unit and a processing for changing the definition of the business process.
